(19) United States
(12) Patent Application Publication
(10) Pub. No.: US 2003/0091851 A1
(43) Pub. Date: May 15, 2003

(54) Method of preparing chitin films

(75) Inventors: Eugene Khor, Singapore (SG); Nealda Leila Muhammad Yusof, Singapore (SG); Lee Yong Lim, Singapore (SG)

Correspondence Address: KLARQUIST SPARKMAN CAMPBELL, LEIGH & WHINSTON, LLP, One World Trade Center, 121 S.W. Salmon Street, Suite 1600, Portland, OR, 97204, US

(73) Assignee: National University of Singapore

(21) Appl. No.: 10/000,421

(22) Filed: Oct. 31, 2001

(51) Int. Cl. B32B 7/02

(52) U.S. Cl. 428/532

(57) ABSTRACT

The invention provides a method of preparing chitin films and novel chitin films produced by the method of the invention. In the invention, chitin solution is coagulated to form a gel which is then pressed to form a film. The film, still under press is further processed to remove residual solvent and the film is then washed. An absorbent-matrix may be introduced into the chitin solution to form a swellable film and the invention also provides a method of preparing an absorbent-matrix by mixing two or more polymer solutions to form a precipitate, dispersion or coacervate which is then isolated and dried to form the absorbent matrix.

### FIELD OF INVENTION

The present invention relates to a method of preparing chitin films. The invention also relates to a method of preparing an absorbent-matrix that may be used in the preparation of such films. The invention also relates to films produced by the methods of the invention. The films may be used in various membrane and film applications, such as reverse osmosis membranes and as packaging films, and as wound dressings.

### BACKGROUND OF THE INVENTION

Synthetic polymers such as polyethylene, polyurethane and cellophane have long dominated membrane and film manufacture and applications. The plasticity, toughness, strength and melt-processability of synthetic polymers have made them user-friendly, inexpensive and easy to manufacture, leading to widespread usage. The disposal of synthetic polymer films, however, has posed a long-standing environmental problem. Synthetic polymers are mostly non-biodegradable and their improper disposal can cause severe environmental pollution and hazards.

Synthetic polymers have been used as occlusive wound dressing materials to aid in wound protection and the creation of the desirable physiological conditions for rapid healing. These polymers are used for wound dressings because they are easy to process into various forms such as films, foams and gels and because of their non-toxic nature, bioinertness and ease of sterilization. Examples include hydrophilic polyurethane, polyethylene oxide, PTFE, HEMA, polyacrylamides, polyisobutylene, polyhydric alcohol, polyvinyl chloride, silicone rubber and acrylonitrile rubber, which are used in wound dressings either as the main matrix, a part of a blend or a component of a composite. An important shortcoming of these occlusive dressings is the potential microbial proliferation that may become uncontrolled in the warm, moist environment of the wound bed beneath the dressing, leading to wound infection and suppuration. Although antibiotics, antiseptics and wound dressing impregnated with antimicrobial agents are available to diminish infection, rapid wound closure is ultimately the most effective and desirable way to lessen exposure and susceptibility.

More recently, the use of natural materials in wound dressings to further enhance the healing rate has been practiced. These natural materials include gelatin, pectin, starch, cellulose, alginate, chitin, collagen, polyamino acids, hyaluronates and dextran. The structures of these materials, composed of sugar and/or amino acid residues, are analogues to the protein and growth factor structures in the human body. Therefore, natural materials are, at first inspection, preferable to synthetic polymers as their interaction with wounds may better stimulate the appropriate physiological responses required for cellular regeneration and tissue restructuring.

Chitin (β-1,4-linked 2-acetamido-2-deoxy-D-glucose) is an unbranched polysaccharide of considerable promise in the field of biomedical research. It exists in nature as protein complexes in the exoskeleton of insects and crustacea, and crosslinks with polyhydroxyphenols to harden the cuticles and as components of the cell wall of marine algae and fungi. In nature, chitin is biodegradable and therefore, has the potential to be made into non-toxic and biocompatible material. It has an estimated molecular weight of 1 to 2×10⁶ daltons, with a typical degree of N-acetylation of >50%. N-deacetylation leading to a lower degree of N-acetylation (<40%), results in chitosan. Chitin has been made into films with high tensile strength. The monomeric unit of chitin, N-acetylglucosamine is known to accelerate wound healing and chitin is therefore, an attractive candidate as a wound dressing material. In accelerating the healing process, N-acetylglucosamine in chitin is more superior to the glucosamine found in chitosan (Ed. Muzzarelli R A A, Peter M G. Chitin Handbook. European Chitin Society, 1997).

However, chitin exhibits poor solubility, swellability, reactivity and processability. Despite these drawbacks, chitin continues to receive widespread attention, including in the biomedical industry because of its abundance, biodegradability, non-toxicity, chemical inertness and its many potential applications. Research to convert chitin into forms that are practical, efficient and user-friendly over the past 30 years has grudgingly yielded gels, films, fibers and sponges.

For many years, chemical modification of chitin has been attempted to overcome its intractability and insolubility. Xanthogenation of alkali-chitin-chitosan produces a viscose that can be used to form films, fibers and foams (Yoshikawa, Otsuki, Midorikawa and Terashi, EP 794 223). Hirano and Horiuchi (Int J Biol Macromol 1989;11:253-254) treated chitin solution with acetic anhydride-pyridine or pyridine to generate a partially O-acetylated, rigid, transparent chitin xerogel or a rigid transparent chitin gel. The hydrolysis rate of these chitin gels by hen egg-white lysozyme was shown to be six times higher than that of unmodified crab shell chitin. U.S. Pat. No. 6,025,479 to Khor et al. discloses a reversible water-swellable carboxymethyl chitin gel. Other ways to improve the bioactivity, tractability, transparency, swellability, solubility and film forming properties of chitin includes, substitution with butyric and mercapto residues, blending with poly-2-hydroxyethyl methacrylate and incorporation of glycerol or polyethylene glycol plasticizers. A porous material may also be obtained from a mixture of chitin and a water-soluble polymer such as polyvinyl alcohol and polycaprolactone.

The use of chemical methods to produce chitin products, including chitin wound dressings involves the use of toxic, abrasive chemicals. This is undesirable as they can increase processing costs, lead to depolymerization and make removal of toxic residues difficult. Therefore, the preparation of chitin products without or minimal chemical modifications is desirable.

Chitin film has been prepared by casting a solution of chitin in N, N-dimethylacetamide (DMAc) −5% LiCl and allowing the solution to coalesce into a film under atmospheric moisture (Rutherford and Dunson, Chitin, Chitosan and Related Enzymes, Ed. Zikakis J P, Academic Press, New York 1984, p.136). The report, however, did not mention how the shrinkage and distortion characteristic of chitin was prevented during the film washing stage. The washed chitin film was placed between paper towels and pressed in a book. U.S. Pat. No. 4,029,727 to Austin et al. discloses the renaturation of chitin film from a solution of chitin in chloroacetic acid systems, by addition of an excess of an anhydrous organic liquid which is a non-solvent for chitin. The patent also discloses cold-drawing chitin film to increase the length. The final shape and thickness of the drawn chitin films were not reported. There was also no description as to how necking and shrinkage of the films perpendicular to the draw direction may be prevented.

Gorovoj and Burdukova describe non-woven sheets of mycelial chitin (100, 200 and 500 μm thickness) produced from the mycelial mass of Higher Basidiomycetes for the treatment of wounds. These fibers were reported to possess good elasticity and strength (Adv Chitin Sci 1996;1:430-43). Sagar, Hamlyn and Wales (GB 2 165 865 and EP 460 771) describe the production of a non-woven chitin fabric from microfungal hyphae by mixing the hyphae with another fabric and forming a wet laid mat. Ohshima, Nishino, Yonekura, Kishimoto and Wakabayashi (Eur J Plast Surg 1987;10:66-6) and Kifune, Yamaguchi and Tanze (EPA 0 199 531) describe a method used in paper manufacture whereby chitin fibers were wetspun from a solution dispersed into water and filtered to form a fibrous non-woven chitin layer. Non-woven chitin sheets, however, generally lack mechanical strength and transparency in the dry state. They crack and crumble easily on bending.

These prior techniques have not effectively resolved the problem of shrinkage and distortion, inherent in chitin film, and are unable to control and vary the film properties to meet the requirements of different applications. Therefore, a versatile technique to produce chitin films that are thin, uniform, strong, flexible, conformable, transparent and durable when in the dry state has not been invented.

### SUMMARY OF THE INVENTION

In one aspect, the present invention provides a method of preparing a chitin film comprising the steps of coagulating a chitin solution to form a chitin gel; pressing the gel to form a chitin film; removing residual solvent from the chitin film under press; and washing the film. In one embodiment, the washed chitin film may be dried under press.

The method involves a few simple steps. The reduced complexities and processing steps not only increase the output rate, but also decrease the cost of manufacturing and lessen the difficulties associated with large-scale conversions.

In one embodiment, an absorbent-matrix may be introduced into the chitin solution to produce a swellable film.

Another aspect of the present invention relates to a method of preparing an absorbent-matrix comprising the steps of mixing two or more polymer solutions to form a colloidal precipitate, dispersion or coacervate (“matrix precursor”), isolating the matrix precursor from the solution and drying the matrix precursor to form the absorbent-matrix.

In another aspect, the invention provides a method of preparing a chitin film containing an absorbent-matrix comprising the steps of introducing an absorbent-matrix prepared according to the invention into a chitin solution, coagulating the chitin solution containing the absorbent-matrix to form a chitin gel containing the absorbent-matrix; pressing the gel to form a chitin film containing the absorbent-matrix; removing residual solvent from the film under press and washing the film.

The invention also relates to films prepared according to the invention. The invention in one aspect therefore provides a chitin film which is about 25 to 75 um thick, possesses tensile strength of about 60 to 115 Mpa and/or transparency of about 77 to 88%. In another aspect, the invention provides a chitin film containing an absorbent-matrix which is about 90 um thick and which is swellable.

Chitin films produced according to various embodiments of the invention are thin, transparent, flexible, and strong and may be used in various film applications such as osmosis membranes, packaging and wound dressings. Film distortion is minimized and film shrinkage can be limited to less than about 50% of the original dimensions. They retain flexibility, softness, transparency and durability in the dry state and do not turn soft and slimy when wet.

Other features and advantages of the present invention will become apparent from the following detailed description. It should be understood, however, that the detailed description and the specific examples while indicating preferred embodiments of the invention are given by way of illustration only, since various changes and modifications within the spirit and scope of the invention will become apparent to those skilled in the art from this detailed description.

### BRIEF DESCRIPTION OF THE DRAWINGS

FIG. 1 illustrates the steps of coagulation and cold pressing according to one embodiment of the invention and the film generated.

FIG. 2 is an aerial view of a cold press assembly used in one embodiment of the invention.

FIG. 3 illustrates the steps of preparing an absorbent-matrix according to one embodiment of the invention.

### DETAILED DESCRIPTION OF THE INVENTION

Chitin solution may be prepared by dissolving chitin in a solvent. Chitin from various sources may be used. For example chitin from crabs, lobsters, shrimp and other crustaceans, the cell walls of fungi and the shells of insects may be used, in addition to commercially available chitin. Preferably, the degree of acetylation of the chitin is >70%, any extraneous material such as protein and calcium carbonate bound to chitin has been removed and chitin is of grade suitable for biomedical use as may be obtained by following cGMP (current Good Manufacturing Practices). Suitable solvents include dimethylacetamide, N-methylpyrrolidone or mixtures of these amides containing a minor amount of lithium chloride as described in U.S. Pat. Nos 4,062,921 and 4,059,457. Any solvent that provides a stable chitin solution is also suitable and include, for example, methanesulfonic acid and formic acid. The term “stable chitin solution” is intended to describe a solution in which there is no visible indication of precipitation or other insolubility of chitin. The chitin solution may be prepared at a temperature ranging from about 0° C. to 60° C., with lower temperatures being preferred. Most preferably, the solution is prepared at a temperature of about 4° C. to prevent de-polymerization reactions. It is preferred that the chitin solution is homogeneous, does not phase separate or gel up or precipitate chitin from the solvent.

The concentration of chitin solution may be varied depending on the desired properties of the film, such as the desired transparency and strength. In a preferred embodiment, the concentration of chitin is such that the solution is a smooth flowing liquid which will pour and spread uniformly across a mold and this may be achieved with a concentration of about 0.2 to 0.8% chitin. In one embodiment, the solvent dimethylacetamide containing 5% lithium chloride (5% LiCl-DMAc) may be used to prepare 0.2 to 0.8% chitin solution. In one embodiment, 0.5% chitin solution may be prepared. Chitin in this solvent may be dissolved at room temperature or on moderate heating, for example at about 50° C., typically for about 6 hours or longer until no solute, visible to the naked eye, is present. The solution may be filtered through glass wool, under vacuum to give a clear slightly yellowish solution of chitin. Alternatively, the solution may be centrifuged or passed through a chromatographic column to separate any residual insoluble materials, to give a clear slightly yellowish solution of chitin. The chitin solution is normally stored in a refrigerator at 4° C. While the inventors have normally used the solution stored at this temperature within 1 month, the solution should be stable for up to about 6 months. Other suitable refrigeration temperatures may be used for storage, for example temperatures ranging from about 15° C. to about −20° C. However, since DMAc has a freezing temperature of about −20° C., care should be exercised to avoid the temperature at which the solvent freezes.

To form a film of a desired shape, the chitin solution may be cast i.e. poured into a mold of an appropriate shape and size, such as a rectangular, or a circular mold. For example, a rectangular mold of 1 square foot in area with a flat surface is suitable to prepare a film for wound dressing applications. Chitin film of a desired shape may also be obtained by simply dissolving chitin in a container or a mold of appropriate shape and size containing the solvent.

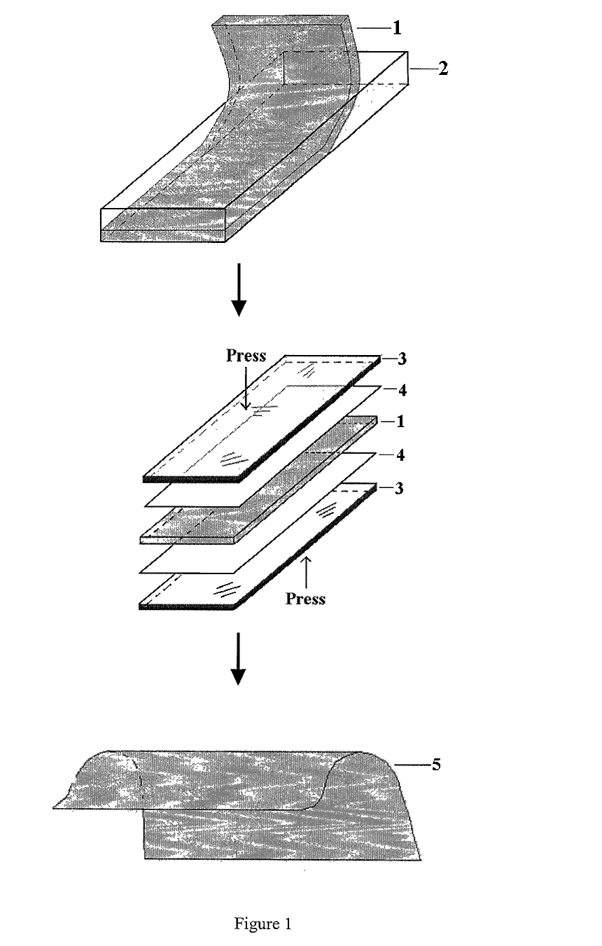

With reference to FIG. 1, in one embodiment, the chitin solution is poured into a rectangular mold with base area ranging from 13×8 cm to 15×25 cm (length×width). In one embodiment, the surface of the mold 2 is smooth and flat to ensure a uniform film surface and to ease removal of the coagulated gel 1 from the mold 2. The chitin solution is cast to an appropriate height to obtain a chitin gel of a desired thickness. The height of the chitin solution cast into the mold should preferably be in the range of about 8 to 20 mm to obtain a coagulated chitin gel that is about 3 to 10 mm in thickness. The corresponding volume of chitin solution to give the range of thickness described is between about 104 cm³ to 375 cm³ for the rectangular mold sizes indicated. The preferred thickness of the gel is about 5 mm thick and may be achieved by pouring the chitin solution to a height of about 10 mm. In another embodiment, the bottom surface of the mold is rendered uneven, for example with serrations or mini spikes, so that in the final film, tiny marks or pinholes are evident on the film's surface exposed to the bottom of the mold, suitable for seeding cells or cellular materials and/or the deposition of growth factors, hormones and the like. The tiny marks or pinholes facilitate the anchoring of seeded or deposited materials onto that surface of the film.

To form a coagulated gel, the mold 2 may be covered, leaving small openings for coagulation to occur. Coagulation occurs as chitin becomes insoluble with the uptake of moisture. As the chitin becomes insoluble, solvent is displaced resulting in essentially an in situ precipitation of the chitin from solution. Accordingly, the chitin solution will coagulate under any condition permitting air circulation and moisture uptake. For example, coagulation may be effected by the simple step of placing the chitin solution in a dust free environment with adequate venting, preferably under a flime hood. The relative humidity may range between about 40% to 100%. Coagulation may be carried out at a temperature ranging from about −20° C. to 120° C., preferably, between about 10° C. to 45° C., and most preferably between about 25° C. to 27° C. The coagulation time will vary depending on the desired thickness of the gel. At a relative humidity of about 80% and at a temperature ranging from ambient temperature to about 37° C., coagulation may be effected for about 24 hours. For example, at about 27° C. to 30° C., coagulation of a chitin solution poured to a height about 10 mm for a period of about 24 h gives a chitin gel 1 having a thickness of about 3 to 5 mm. Depending on the desired thickness, coagulation may be carried out for a longer period. The chitin gel generated after coagulation may be left to age for any time duration before proceeding to the next processing step.

The chitin gel is removed from the mold 2 and placed between the plates 3, to be pressed. The term “cold-pressing” is intended to refer to pressing at ambient temperature, which is preferred. For example, a temperature of about 27° C. to 30° C. is suitable for cold-pressing. The gel may also be pressed at lowered or elevated temperatures, provided degradation of chitin is avoided. The temperature may range from about −10° C. to 80° C. in normal atmosphere (air). The upper temperature limit can be increased to about 150° C. if pressing is effected in an inert atmosphere such as argon or nitrogen or vacuum. Preferably, the surfaces and the materials of plates 3 are such as to permit uniform pressure to be applied. In one embodiment, the plates 3 have smooth and flat surfaces, and are made of a strong, hard and inflexible material, for example, glass. The plates may also be metal or hard plastic plate. In one embodiment, the surface of one or both plates are rendered uneven, for example with serrations or mini spikes, so that in the final film, tiny marks or pinholes are evident on the film's surfaces, suitable for seeding cells or cellular materials and/or the deposition of growth factors, hormones and the like. The tiny marks or pinholes facilitate the anchoring of seeded or deposited materials onto the surface of the film.

During pressing, the chitin gel 1 is placed between the plates 3 and a force is applied to both sides of the plates 3 as shown in FIG. 1. The applied force is uniform and adequate to gradually compress the chitin gel 1 into a thin film 5. In one embodiment, cold pressing is carried out for about 24 hours to form a thin film. As the thickness of the film is determined by the duration of pressing, the plates may be pressed for shorter or longer duration as may be appropriate. A large compression force is not required and care is exercised to reduce damage to the chitin gel 1. The pressure may be applied by any suitable means, including for example, manually by clamping the plates between vises or using clips to secure the plates together. The pressure may also be applied by automated means using compression machine or device that effects compressive pressure/force. Preferably, such machines or device has two surfaces, preferably smooth, but which may be serrated as required and which delivers force to the gel placed between the surfaces.

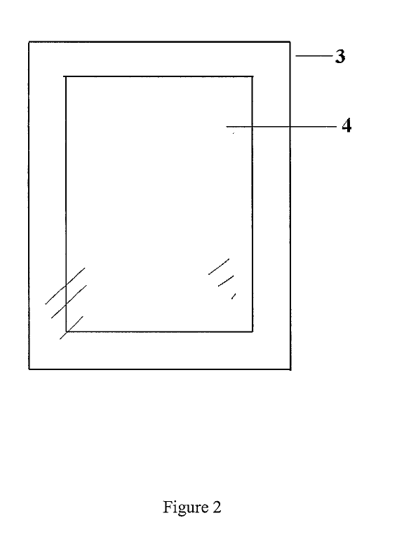

The press plates are preferably lined with an absorbent, non-swellable, and durable material 4, such as cellulose paper, to absorb the solvent from the film. FIG. 2 illustrates the aerial view of a press assembly which may be used in one embodiment of the invention. The plates 3, for example glass plates, and the absorbent lining 4, for example cellulose paper, are visible. Pressing removes excess solvent, exerts an isotropic drawing effect to the film, suppresses the inherent shrinkage and reduces the thickness of the chitin gel.

To remove residual solvent, the chitin film 5, still placed between the plates 3 (i.e. under press), may be heated, preferably in a dry oven, or placed in a vacuum-evacuated chamber or placed in an environmental chamber with relative humidity of about 5 to 10% at a temperature between about 10 to 70° C. During this process, further packing of the chitin polymer chains that were held apart by hydrogen bonding interactions with solvent or air spaces that may be present in the chitin-gel matrix may occur as residual solvent vaporizes. If the film under press is heated to remove residual solvent, the heating temperature should be kept sufficiently low, about 70° C. in normal atmosphere but up to about 150° C. under inert atmosphere or vacuum, to prevent degradation of chitin film 5. A temperature of about 50° C. atmosphere or vacuum, to prevent degradation of chitin film 5. A temperature of about 50° C. or less is preferred. In one embodiment, the temperature is about 50° C. and at this temperature, the solvent may be removed in about 12 hours. Residual solvent may be removed by other suitable means, for example by soaking the plates containing the film in water or a non-solvent such as ethanol, with several changes of water/non-solvent as may be necessary to remove the solvent and as may be confirmed, for example, by HPLC (high pressure liquid chromatography). However, it is not necessary to remove all trace amounts of solvent, as such trace amounts will be removed when the film is washed. Where the solvent is removed by heating, the plates may also be soaked in water/non-solvent and the effluent analysed, for example, by HPLC to confirm sufficient removal of the solvent.

The chitin film is next removed from the plates 3 and washed in a non-solvent i.e. any solvent that can cause coagulation or precipitation of chitin from its solution, such as alcohol or water and more suitably ethanol. The non-solvent effects consolidation of the film in a manner where alignment and interactions of the chitin chains are controlled and inhibited to prevent the formation of a more inflexible and brittle chitin film. In essence, the chitin chains are “frozen” during consolidation to give a more disordered character to the final film. The film is washed in one or more non-solvent washings until all solvent (LiCl-DMAc) is removed as may be confirmed by an appropriate analysis of the effluent, for example HPLC. Alternatively, the film may be soaked in a non-solvent with stirring, or the film can be placed in a dialyzing chamber to wash out residual solvent. The film may be washed at a temperature of about 0° C. to about 70° C. in normal atmosphere but up to about 150° C. under inert atmosphere or vacuum. Suitably, the film is washed at ambient temperature, for example at a temperature of about 27° C. to 30° C.

In one embodiment, the film 5 after washing may be dried between plates 3, preferably with clean, new layers of lining 4 on the plates 3, at about 27° C. to 30° C., although temperatures ranging from about 0° C. up to about 70° C. in normal atmosphere and up to about 150° C. under inert atmosphere or vacuum, are also acceptable. The film is sufficiently dry if no further shrinking of film is observed when the film is released from the plates. The film may be further dried after removal from the plates, typically, for more than 6 hours and up to about 1 week to remove any traces of the washing solvent and stored in a dessicator.

A uniform force is constantly applied onto the plates while the chitin film is under press during removal of residual solvent and drying of the chitin film 5.

Immediately prior to the step of removing residual solvent, the chitin film 5 may be calendered between rollers to orient polymer chains and strengthen the film 5. Suitably, the film is calendered at a temperature of about 27° C. to 30° C. Temperatures ranging from about 0° C. up to around 70° C. in normal atmosphere and up to about 150° C. under inert atmosphere or vacuum are also acceptable. Film 5 is removed from plates 3 and placed between two pieces of absorbent material for example cellulose paper, before being placed between the calendering rollers. The absorbent material will wick away any LiCl-DMAc solvent squeezed out during this process and protect the still fragile film 5 from being damaged by the rollers. Other appropriate means of “wicking away” or removing, or collecting residual solvent may be used in place of cellulose paper. The rollers can be made of a strong, hard, rust- and solvent-resistant, and smooth material, such as stainless steel. Preferably, the roller is made of an elastomeric material that is not hard enough to damage the film 5. For stainless steel rollers, the distance between rollers is preferably kept smaller than the thickness of the chitin film 5 but greater than half its thickness to prevent film damage.

The chitin film obtained by the described method is flexible, transparent, strong, thin, smooth, homogeneous and conformable. It is not brittle and can be bent, folded and crumpled without breaking and crumbling.

To obtain a swellable chitin film, particularly useful for wound dressing applications, an absorbent-matrix may be introduced within the chitin film. An absorbent-matrix as that term is used herein refers to any material capable of absorbing fluid. Preferably, the absorbent-matrix is soft, compressible, spongy or with a sponge-like structure. The pore size of the absorbent-matrix may vary, and the absorbent-matrix may be prepared from various synthetic and/or natural materials. In one embodiment, an absorbent-matrix may be prepared as follows.

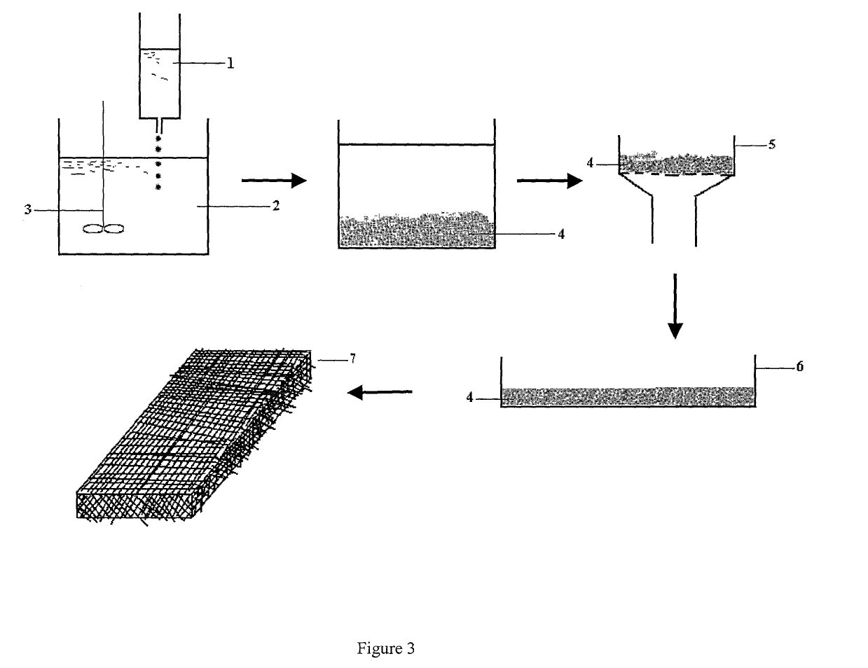

With reference to FIG. 3, carboxymethyl chitin (CM-chitin) solution 2 is mixed with chitin solution 1 with stirring 3 to form a colloidal precipitate, dispersion or coacervate 4 (matrix precursor). Chitin solution in a suitable solvent system, as described previously may be used. In one embodiment, the chitin solution is 0.1% chitin in 5% LiCl/DMAc. CM-chitin is normally synthesized using a chemical process, for example, as described in R. Trujillo, Preparation of Carboxymethylchitin, Carbohydrate research volume 7, 483-485, 1968. CM-chitin solution may be prepared by dissolving CM-chitin powder in deionized water. The solution may also be prepared from chitin as described in Example 6. Chitin from various sources may be used to prepare CM-chitin solution. For example chitin from crabs, lobsters, shrimp and other crustaceans, the cell walls of fungi and the shells of insects may used in addition to commercially available chitin. Preferably, the degree of acetylation of the chitin is >70%, any extraneous material such as protein and calcium carbonate bound to chitin has been removed and chitin is of grade suitable for biomedical use as may be obtained by following cGMP.

The concentration of CM-chitin solution and chitin solution may be varied to achieve different characteristics of the absorbent-matrix. In one embodiment, a concentration of CM-chitin and chitin of about 0.1% to 10% may be conveniently used.

The CM-chitin solution may be replaced by any other synthetic or natural polymer solutions, preferably, solutions of chitin derivatives, including, for example, phosphoryl-chitin, alkyl-chitin, aryl-chitin, sulfonic-acids and carboxylic-based chitins, acryloyl-chitin and other known chitin derivatives. Chitin derivatives and their preparations are described, for example in K. Kurita, Chitin and Chitosan Derivatives, Chapter 1.15 in Desk Reference of Functional Polymers & Synthesis and Applications.

The matrix precursor formed in the solution mixture may be washed with deionized water to remove the solvent, for example, LiCl/DMAc, and isolated by filtration 5 and poured into a mold of a desired shape 6 and dried to form the absorbent-matrix 7. The matrix precursor may be dried by any convenient means, including by air drying, spray drying or freeze drying. In one embodiment, it is freeze dried and the freezing temperature may range from about −50° C. to −20° C. and the freeze-drying temperature from about −50° C. to −45° C. with pressures in the range of 10⁻² to 10⁻⁴ Torr to give the absorbent-matrix. In one embodiment, the matrix precursor is freeze dried by freezing at about −20° C. to −10° C. for about 12 to 24 hours and freeze drying at a pressure of about 700 milliT, condenser temperature of about −50° C. and shelf temperature of about 25° C. for about 24 hours.

The dense chitin-based absorbent-matrix formed by this method is extremely soft and can be pressed, bent, folded and rumpled without breaking. It acts as the fluid-absorbing component in the final film. While the preparation of the absorbent-matrix using CM-chitin and chitin solutions has been described, the absorbent-matrix may be prepared using other natural and synthetic materials capable of forming sponge and sponge-like absorbent-matrixes with varying pore sizes, such as pads and foams. These other materials include natural materials such as cellulose, chitin derivatives, alginate, collagen, hyaluronic acid, gelatin, starch and synthetic materials such as polyurethane, polyethylene and polypropylene. Sponges, pads and foams may be prepared using these materials by methods known in the art such as bubbling gas into the polymer solution, spraying and aerosol introduction.

To form a chitin film containing an absorbent-matrix, the absorbent-matrix is introduced into the chitin solution previously described, for example by casting the solution onto the matrix, to form a coagulated gel containing the absorbent-matrix and further processed as previously described to form a chitin film containing the absorbent-matrix.

The chitin film containing the absorbent-matrix is about 90 μm thick, absorbs water and swells into a gel, about 1210 μm thick. The absorbent-matrix spreads the loaded chitin, preventing homogenous coagulation and consolidation throughout the film and disrupts the hydrogen bond between chitin chains that is responsible for the intractable, non-absorbent and non-swellable nature in chitin. Chitin chains, freed from restraining inter- and intra-chain hydrogen bonds, are able to move apart as water is imbibed and allow the absorption of more water, causing swelling. This characteristic is highly desirable in wound dressing applications whereby excess exudate may be absorbed from the wound, while maintaining the moist wound environment conducive for healing. For dry or lightly exudating wounds, the absorbent-matrix-containing chitin film dressing can remain hydrophobic and occlusive, preventing the loss of wound moisture. Therefore, absorption and swelling only occurs in the presence of voluminous amounts of fluid. The dressing may therefore be applied to wounds at various stages of healing. The chitin film containing the absorbent-matrix is also transparent, flexible, strong, supple, smooth and soft.

Given below are several specific examples for producing a transparent, flexible chitin film. It should be noted that these examples are illustrative and can be varied including by varying coagulation times, solution casting volume, pressing force, solution concentration, to increase flexibility, elasticity, transparency and swellability to achieve chitin thin films of various thicknesses, transparencies and strengths. Additives such as pigment, stabilizer, heat-resistant agent, plasticizer, binder, preservative, biocide, anesthetic, antioxidant, filler and another polymer, synthetic and/or natural, may also be introduced into the chitin solution to increase flexibility, elasticity, transparency, swellability and other specific properties to the final product. For example, one or more of chitin derivatives and oligomers of chitin may be added to the chitin solution to modify the properties of the final film.

Moreover, solutions of chitan (poly-n-acetyl glucosamine), chitosan and oligomeric forms of chitin may also be used to form films, as described above for chitin. The oligomeric forms of chitin preferably have a molecular weight range of 10³ to 10⁴ daltons. Dilute acids, preferably 0.5% to 2% acetic acid may be used to prepare chitosan solution and other appropriate solvents to prepare chitosan and chitan solutions are known in the art. Chitan, chitosan and oligomeric forms of chitin may be commercially available. For example, Pronova supplies chitosan and may also supply oligomers of chitin. Marine Polymer Technologies produces chitan and may supply chitan commercially.

All references cited herein are fully incorporated by reference.

Material Characterization

Light Transmittance

The transparency of each film was obtained by measuring its transmittance with a Shimadzu UV-1601 UV-visible spectrophotometer between 400-800 nm using air as reference.

Tensile Test

The mechanical behavior of film samples was measured with an INSTRON 4302 uniaxial tensile tester at 26° C., relative humidity of 50% and a crosshead speed of 1 mm/min.

Thermal Analysis

Thermogravimetric analysis (TGA) of film samples was obtained using a SDT 2960 Simultaneous DTA-TGA analyzer (TA Instruments). Decomposition profiles were obtained with 5 to 10 mg of film samples placed in alumina sample pans and the temperature increased from 27° C. to 500° C. at a heating rate of 10° C./min. Thermomechanical analysis (TMA) was conducted using a TMA 2940 analyzer (TA Instruments), from 27° C. to 210° C. for P24 and P96, and from 27° C. to 240° C. for 24W. The films were held under static uniaxial tension of 0.05 N by a quartz expansion probe. The test dimension of film specimens was 12.5×2.0 mm. All thermal characterizations were performed under a 120 cc. flow of nitrogen atmosphere.

Water Vapor Transmission Rate (WVTR)

The water vapor transmission rate was measured according to the ASTM E96-95 method, with slight modifications. The “Dry” WVTR's test area was set at 50 mm diameter for each chitin film sample with an allowance of 10 mm permitted for each test sample. Plastic cups with negligible water vapour transmittance and having 5 mm wide ledges extending from their rims, were filled with water up to a level of about 20 mm from the rim top. The film samples were adhered onto the cup ledge using a water-resistant adhesive, for example, silicone. The assembly was weighed to the nearest 0.01 g (Wₗ) and placed into a chamber maintained at a temperature of 25° C. to 27° C. and a relative humidity of 10% to 30% RH. The assembly was removed from the chamber after 3 hours, weighed to the nearest 0.01 g (Wₒ) and immediately returned to the chamber. The ‘dry’ WVTR of the chitin films (normalized to grams of water transmitted per square meter of sample area over a period of 24 hours) was calculated as follows,

$$WVTR = \frac{{W}_{i} - {W}_{o}}{At}$$

where:

Wᵢ was the initial weight of the assembly in grams

Wₒ was the weight of the assembly in grams at time, t

A was the WVTR test area of the sample in square meters

t was the time duration between Wₒ and Wᵢ in hours

A dummy test was carried out using aluminum foil as the test sample to confirm that the WVTR of the plastic cup and the silicone adhesive were negligible.

The “Wet” WVTR's test area was set at 32 mm in diameter for each chitin film sample with an allowance of 10 mm permitted for each test sample. Plastic cups with negligible water vapour transmittance and having 4 mm wide ledges extending from their rims, were filled with water up to a level of about 10 mm from the rim top. The film samples were adhered onto the cup ledge using a water-resistant adhesive, for example, silicone. The assembly was weighed to the nearest 0.01 g (Wᵢ) and placed into a chamber maintained at a temperature of 25° C. to 27° C. and a relative humidity of 10% to 30% RH. The assembly was removed from the chamber after 3 hours, weighed to the nearest 0.01 g (Wₒ) and immediately returned to the chamber. The ‘wet’ WVTR was obtained using the same formula for calculating ‘dry’ WVTR.

### EXAMPLE 1

FILM P24

Chitin flakes were obtained from Polysciences Inc. and purified prior to use by soaking in 5% NaOH solution at room temperature with mechanical stirrer agitation for 7 days, and washed with water until free of NaOH. The flakes were next soaked in 1M HCl for 1 hour, washed with water until HCl free and dried. 5 g of this purified chitin flakes were dissolved in 1 L of DMAc/5% LiCl (50 g of LiCl) at 10° C. in a refrigerated shaking incubator to give a 0.5% chitin solution. The solution was filtered through glass wool, collected and stored in the refrigerator until used. 155 cm³ of this chitin solution was cast into a rectangular mold with base dimensions 15×25 cm. The height of the solution in the mold was 10 mm. The mold was covered with aluminum foil and placed in a fume hood. Pinholes were made in the foil with a needle to permit interaction with moisture at room temperature to give a chitin gel. Gelling time was set at 24 hours, a time period that would permit minimum gel shrinkage.

The resulting chitin gel was placed between 2 pieces of cellulose filter paper (30 mm in diameter trimmed with a pair of scissors to cover the gel). The gel/filter paper assembly was next placed between two rectangular glass plates (150 mm×115 mm×5 mm) and held together by clips, one clip placed in the middle of each edge, securing all four edges of the glass plates to initiate cold-pressing. Cold-pressing by the application of mechanical pressure maintains the chitin fibers in the gel in a stretched state while slowly compressing the thickness of the gel as the retained chitin solvent is slowly expelled. The chitin solvent soaked cellulose paper was replaced frequently with new, dry ones.

This pressed film was next heated in a dry oven at 50° C. for 12 hours under continuous mechanical stress to remove residual solvent while arresting the reorganization (i.e. disrupts the consolidation and alignment of individual chitin molecules with each other that results in compactness and a brittle chitin film) or shrinking of the chitin structure as the solvent molecule is expelled. The chitin film was released from the press and washed in ethanol for 12 hours at ambient temperature, with regular changes of the ethanol. Ethanol serves as the final coagulation step i.e. it completes the removal of trace chitin solvent and matures the solid stable state of the chitin film after pressing. The washed chitin film was immediately cold pressed again between plates lined with new, clean cellulose paper under a uniform force for an additional 48 hours, with regular changes of the cellulose paper. Cold-pressing was utilized in this instance as a precaution to prevent any shrinkage during the removal of ethanol. The dry chitin film, designated P24, was stored in a chamber kept at 30% RH (relative humidity).

### EXAMPLE 2

FILM P96

The same chitin solution was prepared, filtered and cast similar to Example 1. Gelling time was set at 96 hours.

The chitin gel was removed from the mold after 96 hours (Sample P96), and cold pressed under a uniform force as in example 1, between plates lined with cellulose paper. The soaked cellulose paper was replaced frequently with new, dry ones. After pressing out excess 5%LiCl/DMAc solvent squeezed out of the chitin gel from pressing, the cold press assembly with the chitin film formed within was heated in a dry oven at 50° C. for 12 hours to remove residual solvent. The chitin film was released from the press and washed in ethanol for 12 hours at ambient temperature, with regular changes of the ethanol. The ethanol washed chitin film was immediately cold pressed again between plates lined with new, clean cellulose paper under a uniform force until dry, with regular changes of the cellulose paper. The dry chitin film, designated P96, was stored in a chamber kept at 30% RH (relative humidity).

### EXAMPLE 3

FILM 24W

The same chitin solution was prepared, filtered and cast similar to Example 1. Gelling time was set at 24 hours.

The chitin gel was removed from the mold after 24 hours of coagulation, rinsed in water (until no chitin solvent was detected) and air-dried without pressing (unpressed). In the presence of water, chitin consolidates relatively quickly into a brittle light yellow film. The dry chitin film, designated 24W, was stored at room temperature and 30% relative humidity.

Experiment 1

Samples of films P24, P96 and 24W were cut into strips 15 mm in width and having a test length of 60 mm. The transparency, shrinkage and thickness of each chitin film sample were measured and the results are shown in Table 1.

TABLE 1

| Sample | Transmittance / % | | Film shrinkage / % | | Thickness / μm | |
|---|---|---|---|---|---|---|
| P24 | 87.63 | (1.44) | 29.90 | (3.10) | 28 | (4.19) |
| (Example 1) | | | | | | |
| P96 | 78.94 | (5.71) | 75.30 | (1.50) | 73 | (8.77) |
| (Example 2) | | | | | | |
| 24 W | 14.50 | (16.58) | 87.57 | (2.57) | 460 | (0.08) |
| (Example 3) | | | | | | |

Figures in parentheses = standard deviation

Film shrinkage refers to the decrease in dimension of the total surface area of the film as measured by a meter rule from the coagulated gel state to the pressed, washed and dried film state. Cold pressed chitin thin films, P24 and P96, have high transparencies and are relatively thin compared to unpressed chitin films. Cold pressing also suppresses shrinkage in the films by up to approximately 60%. Longer gelling (coagulation) duration (96 hours), for sample P96 (Example 2), gives a coagulated gel much smaller than the mold size, resulting in a thicker film with reduced transparency compared to sample P24. Gelling duration of 24 hours produces a less consolidated coagulated gel exactly the size of the mold.

Experiment 2

The tensile properties of samples P24 and P96 are illustrated in Table 2 below.

TABLE 2

| Samples | Tensile strength*/ MPa | | Young's modulus / MPa | |
|---|---|---|---|---|
| P24 (Example 1) | 60.05 | (14.95) | 3659 | (744) |
| P96 (Example 2) | 77.21 | (4.57) | 2703 | (458) |
| 24W (Example 3) | 38.34 | (9.54) | 1241 | (470) |

Figures in parentheses = standard deviation
*A tensile strength of about 115 Mpa was also observed for films made according to the invention.

Cold pressing improves tremendously the tensile strength and modulus of chitin films by almost 2 times. In this invention, superior mechanical properties are retained with decreased film thickness and increased film flexibility, through cold pressing.

Experiment 3

The thermal properties of the chitin thin films explain why and how film flexibility is achieved through cold-pressing of the chitin gels. TGA (Table 3) and TMA results illustrate the thermal behaviour of samples P24 and P96.

TABLE 3

| Samples | TGA moisture content / % |
|---|---|
| P24 (Example 1) | 13.5 |
| P96 (Example 2) | 11.1 |
| 24W (Example 3) | 6.7 |

Unpressed chitin films contain less absorbed/retained moisture resulting in a brittle and stiff texture compared to cold pressed films P24 and P96. The plasticizing effect of high percentage of moisture content in P24 and P96 imparts suppleness and softness to the films. TMA records the contraction (0.001-0.002%) of films P24 and P96 from 27° C. to 100° C. due to the release of bound moisture. The large negative thermal expansion coefficient within this temperature range (results not shown) is evidence of the hydrophobic character of chitin and the absence of thermoplasticity.

Experiment 4

The ‘dry’ WVTR and ‘wet’ WVTR of chitin films P24 and P96 are shown below in Table 4. The ‘dry’ WVTR of the chitin films fall within the WVTR range for intact skin, which is between 240 and 1920 g/m²/24 h. The ‘wet’ WVTR of the chitin films are more than twice the ‘dry’ WVTR and are also higher than the WVTR for intact skin. This shows that the chitin film dressings will transmit substantially more moisture vapour when in contact with a wetter wound than they do when in contact with a dryer wound. The chitin film dressings will essentially retain more moisture for dry, lightly exudating wounds. During the determination of ‘wet’ WVTR, the film surface not in contact with water remains dry.

TABLE 4

| Samples | ‘dry’ WVTR (g/m²/24h) | | ‘wet’ WVTR (g/m²/24h) | |
|---|---|---|---|---|
| P24 (Example 1) | 568.2 | (33.6) | 2348.1 | (167.3) |
| P96 (Example 2) | 552.0 | (28.4) | 2548.3 | (134.0) |
| 24W (Example 3) | 847.1 | (49.9) | 2070.2 | (181.2) |

Figures in parentheses = standard deviation

### EXAMPLE 4

P24C

The same chitin solution was prepared, filtered and cast similar to Example 1.

The chitin gel was removed from the mold after 24 h, and cold pressed under a uniform force between plates lined with cellulose paper. The soaked cellulose paper was replaced frequently with new, dry ones. After pressing out excess 5% LiCl/DMAc solvent, the chitin film formed was released from the cold press, placed between two pieces of new, dry cellulose paper and was calendered unidirectionally between steel rollers at 27° C. to 30° C. Subsequently, the calendered film was returned to the cold press and the entire assembly was heated in a dry oven at 50° C. for 12 hours to remove residual chitin solvent and to further coagulate the chitin film. The calendered chitin film was released from the press and washed in ethanol for 12 hours, with regular changes of the ethanol. The washed chitin film was immediately cold pressed between plates lined with new, clean cellulose paper under a uniform force until dry, with regular changes of the cellulose paper. The dry calendered chitin film, designated P24C, was stored in a chamber kept at 30% RH (relative humidity).

### EXAMPLE 5

P96C

In another embodiment of the invention, the same chitin solution was prepared, filtered and cast similar to Example 1. The chitin gel was removed from the mold after 96 hours and cold pressed under a uniform force between plates lined with cellulose paper. The soaked cellulose paper was replaced frequently with new, dry ones. After pressing out excess 5% LiCl/DMAc solvent, the chitin film formed was released from the cold press, placed between two pieces of new, dry cellulose paper and was calendered unidirectionally between steel rollers at 27° C. to 30° C. Subsequently, the calendered film was returned to the cold press and the entire assembly was heated in a dry oven at 50° C. for 12 hours to remove residual solvent and to further coagulate the chitin film. The calendered chitin film was released from the press and washed in ethanol for 12 h, with regular changes of the ethanol. The washed chitin film was immediately cold pressed between plates lined with new, clean cellulose paper under a uniform force until dry, with regular changes of the cellulose paper. The dry calendered chitin thin film, designated P96C, was stored in a chamber kept at 30% RH (relative humidity).

Experiment 5

The tensile properties of calendered chitin films are as tabulated in Table 5.

TABLE 5

| Samples | Tensile strength / MPa | | Young's modulus / MPa | |
|---|---|---|---|---|
| P24C (Example 4) | 63.78 | (7.20) | 6021 | (578) |
| P96C (Example 5) | 66.21 | (8.49) | 5019 | (1978) |

Figures in parentheses = standard deviation

Calendering does not significantly change the tensile strengths of the chitin films. The strengthening effect of calendering is reflected in the Young's modulus values of calendered films, which have increased almost two-fold compared to P24 and P96 (Examples 1 and 2), from about 3700 MPa to 6000 MPa for P24C, and from about 2700 MPa to 5000 MPa for P96C.

### EXAMPLE 6

2 to 4 g of the purified chitin flakes from Polyscience, PA, USA was stirred in deionized water for 1 hour at ambient temperature. The chitin powder was filtered and re-suspended in 20 ml or more of 40% to 60% (w/v) NaOH solution. The suspension was stirred for 1 hour at 28° C. to 30° C., followed by freezing at a temperature between −20° C. and −10° C. overnight (approximately 15 hours). The frozen alkali-chitin was thawed and stirred for 1 hour at 28° C. to 30° C. After one further freeze-thaw cycle, the alkali-chitin slurry was stirred vigorously into a solution containing at least 45 g monochloroacetic acid in 250 ml 2-propanol, in a volume ratio of 1:3. The reaction between alkali-chitin and monochloroacetic acid was carried out for 10 to 15 min at ambient temperature. The CM-chitin reaction product was transferred into a Spectra/Por No. 3 dialysis membrane and rinsed in deionized water until the washings were of neutral pH.

The alkali-free CM-chitin solution obtained was diluted with deionized water up to 500 to 1000 ml. 1000 ml of 0.1% chitin solution, obtained by dissolving 1 g of chitin flakes (Polyscience, PA, USA) in 1000 ml of a solvent system comprising 50 g LiCl in 1000 ml N, N-dimethylacetamide (5% LiCl/DMAc) was allowed to trickle into the CM-chitin solution under high speed stirring (700 rpm is preferred) at ambient temperature. The colloidal coacervate that formed was washed with deionized water several times until the supernatant was clear. This was followed by filtration to retrieve the colloidal coacervate that was next poured into a rectangular, plastic mold with dimensions of about 13×8 cm, up to a height measuring 10 mm. The colloidal coacervate was frozen at a temperature of −20° C. to −10° C. for 12 to 24 hours, and freeze-dried for 1 day at a pressure of 700 milliTorr, a condenser temperature of −50° C. and shelf temperature of 25° C., to obtain a dense chitin absorbent-matrix 7.

A 0.5% chitin solution was poured into a 13×8 cm rectangular plastic mold containing the chitin absorbent-matrix and allowed to penetrate the interstices of the chitin absorbent-matrix. The mold was covered with aluminum foil and pinholes made on the foil with a needle to permit coagulation of chitin solution into a gel. Gelling time was set at about 24 hours to achieve minimum gel shrinkage. The resulting chitin gel containing the absorbent-matrix was subjected to cold-pressing, removal of residual solvent, washed and dried as described in Example 1.

The chitin thin film containing an absorbent-matrix was flexible, soft, supple, conformable and strong, having a thickness of about 90 um and appeared translucent. This chitin film containing the absorbent-matrix swelled into a gel measuring about 1210 um thick upon absorption of water. This characteristic is highly desirable in wound dressing applications whereby excess exudate may be absorbed from the wound, while maintaining the moist wound environment conducive for healing. In atmospheric conditions, the chitin film containing the absorbent-matrix is hydrophobic in nature and is suited for dry to lightly exudating wounds where occlusivity is required to prevent desiccation. A normal chitin film with the same initial thickness, made by cold-pressing of washed chitin gels swelled only to about 190 um in thickness.

We claim:

1. A method of preparing a chitin film comprising the steps of:
(a) coagulating a chitin solution to form a chitin gel;
(b) pressing the chitin gel to form a chitin film;
(c) removing residual solvent from the chitin film under press; and
(d) washing the chitin film.

2. The method according to claim 1 further comprising the step of dissolving chitin in a solvent to form the chitin solution.

3. The method according to claim 2 wherein the concentration of chitin in the chitin solution is about 0.2 to 0.8%.

4. The method according to claim 3 wherein the solvent is 5% LiCl/DMAc.

5. The method according to claim 4 wherein the concentration of chitin is 0.5%.

6. The method according to claim 5 further comprising the step of casting the chitin solution prior to the step of coagulation.

7. The method according to claim 1 wherein the chitin solution is coagulated as chitin becomes insoluble with the uptake of moisture.

8. The method according to claim 7 wherein the chitin solution is coagulated at a relative humidity of about 40 to 100%.

9. The method according to claim 8 wherein the chitin solution is coagulated at a temperature of about 10 to 45° C.

10. The method according to claim 9 wherein the chitin solution is coagulated at a temperature of about 25 to 27° C.

11. The method according to claim 7 wherein the chitin gel is cold pressed.

12. The method according to claim 11 wherein the chitin gel is pressed between glass plates.

13. The method according to claim 12 wherein the glass plates are lined with cellulose paper.

14. The method according to claim 13 wherein chitin gel is pressed under uniform pressure.

15. The method according to claim 11 wherein the residual solvent is removed by heating the film under press in a dry oven at about 50° C.

16. The method according to claim 15 wherein the chitin film is washed in ethanol at a temperature of about 27 to 30° C.

17. The method according to claim 1 further comprising the step of drying the washed chitin film under press.

18. The method according to claim 1 further comprising the step of calendering the chitin film prior to the step of removing residual solvent.

19. The method according to claim 18 wherein the chitin film is calendered between elastomeric rollers or steel rollers at a temperature of about 27 to 30° C.

20. The method according to claim 6 wherein the chitin solution is cast in a rectangular mold.

21. The method according to claim 20 wherein bottom surface of the mold is smooth.

22. The method according to claim 20 wherein bottom surface of the mold is rendered uneven.

23. The method according to claim 22 wherein the bottom surface is rendered uneven with serrations or mini spikes.

24. The method according to claim 20 wherein the chitin solution is cast to a height of about 10 mm.

25. The method according to claim 24 wherein the chitin solution is coagulated as chitin becomes insoluble with the uptake of moisture for about 24 hours at ambient temperature.

26. The method according to claim 25 wherein the chitin gel is cold pressed between glass plates lined with cellulose paper, under uniform pressure for about 24 hours.

27. The method according to claim 26 wherein the residual solvent is removed by heating the film under press in a dry oven at a temperature of about 50° C. for about 12 hours.

28. The method according to claim 27 wherein the chitin film is washed in ethanol for 12 hours at ambient temperature.

29. The method according to claim 28 further comprising the step of drying the chitin film by cold pressing the film between plates lined with cellulose paper, under uniform force for 48 hours.

30. A method of forming an absorbent-matrix comprising the steps of mixing two or more polymer solutions to form a colloidal precipitate, dispersion or coacervate (matrix precursor), isolating the matrix precursor from the solution and drying the matrix precursor to form an absorbent-matrix.

31. The method according to claim 30 wherein the polymer solutions are carboxymethyl-chitin solution and chitin solution.

32. The method according to claim 31 wherein the concentration of each of carboxymethyl-chitin and chitin in each solution is about 0.1 to 10%.

33. The method according to claim 32 wherein the chitin solution is a solution of 0.1% chitin in 5% LiCl/DMAc.

34. The method according to claim 33 wherein the matrix precursor is isolated by filtration.

35. The method according to claim 34 further comprising the step of pouring the matrix precursor into a mold prior to drying.

36. The method to claim 35 wherein the matrix precursor is freeze dried by freezing at about −20° C. to −10° C. for about 12 to 24 hours and freeze drying at a pressure of about 700 milliT, a condenser temperature of about −50° C. and shelf temperature of about 25° C. for about 24 hours.

37. A method of preparing a chitin film containing an absorbent-matrix comprising the steps of introducing an absorbent-matrix prepared according to claim 31 into a chitin solution, coagulating the chitin solution containing the absorbent-matrix to form a chitin gel containing the absorbent-matrix; pressing the gel to form a chitin film containing the absorbent-matrix; removing residual solvent from the film under press and washing the film.

38. A chitin film containing an absorbent-matrix prepared according to the method of claim 37.

39. The method according to claim 1 further comprising the step of introducing an absorbent-matrix into the chitin solution.

40. The method according to claim 39 wherein the absorbent-matrix is prepared according to the method of claim 31.

41. A chitin film which is about 25 to 75 um thick and possesses tensile strength of about 60 to 115 Mpa.

42. A chitin film which is about 25 to 75 um thick and possesses transparency of about 77 to 88%.

43. A chitin film which is about 25 to 75 um thick and possesses tensile strength of about 60 to 115 Mpa and transparency of about 77 to 88%.

44. The chitin film according to claim 43 wherein the film shrinkage is less than about 50%.

45. An absorbent-matrix-containing chitin film which is about 90 um thick and which is swellable.

46. The absorbent-matrix-containing chitin film according to claim 45 which swells to a thickness of about 1210 um.
